(19) United States
(12) Patent Application Publication
(10) Pub. No.: US 2006/0011885 A1
(43) Pub. Date: Jan. 19, 2006

(54) Liquid bleaching composition

(75) Inventors: Delford Ian Christmas, Montvale, NJ (US); Ramakrishnan Hariharan, Montvale, NJ (US)

Correspondence Address: NORRIS, MCLAUGHLIN & MARCUS, 875 THIRD AVE, 18TH FLOOR, NEW YORK, NY, 10022, US

(73) Assignee: Reckitt Benckiser Inc., Parsippany, NJ (US)

(21) Appl. No.: 10/530,743

(22) PCT Filed: Oct. 13, 2003
(86) PCT No.: PCT/GB03/04433

§ 371 Date: Apr. 8, 2005

(30) Foreign Application Priority Data
Oct. 12, 2002 (GB) 0223839.2

(51) Int. Cl. A62D 3/00

(52) U.S. Cl. 252/186.1

(57) ABSTRACT

The present invention relates to thickened pourable aqueous bleach composition which contains abrasives, suitable for use in cleaning hard surfaces such as are found, for example, in lavatories and kitchens which are highly alkaline.

This invention relates to a pourable aqueous bleach composition which contains abrasives, suitable for use in cleaning hard surfaces such as are found, for example, in lavatories and kitchens.

It is particularly difficult to produce aqueous bleach stable, thickened abrasive cleaning compositions which offer the simultaneous benefits of: good bleach stability which provides an acceptable shelf life for a product; acceptable viscosity characteristics; relatively low cost; and of course efficacy in removing stains and in effectively disinfecting surfaces, especially on inclined hard surfaces such is tiled, enameled and porcelain surfaces such as are typically associated with bathrooms or kitchens. While the art provides a number of such compositions directed to satisfying these requirements, these compositions have not uniformly met with success. The present invention overcomes many of these shortcomings in the prior art.

A composition according to the invention is a stable, single phase, thickened bleach containing composition capable of adhering to vertical or inclined surfaces longer than thinner compositions. Such a composition is effective as an agent for stain and soil removal as well as disinfection. The high level of bleach stability and single solution phase behavior of the composition enables the composition to have an acceptable shelf life. The compositions exhibit little or no visibly discernible syneresis during its normal shelf life (6-9 months) and shelf life storage conditions (20° C.). In particularly preferred embodiments the compositions exhibit little or no syneresis under accelerated aging test conditions and at the same time exhibited good bleach stability. Such is particularly important for use and storage of the product in warm climate countries (South Africa, Brazil, etc.).

The present invention provides a liquid thickened chlorine bleach composition comprising
an active chlorine source;
at least one surfactant selected from anionic surfactants, amine oxides, and mixtures thereof;
at least one thickener selected from polycarboxylates, polyacrylamides, clays, gums, cellulose derivatives, and mixtures thereof;
at least one abrasive material selected from oxides, carbonates, quartzes, siliceous chalk, diatomaceous earth, colloidal silicon dioxide, alkali metasilicates, organic abrasive materials selected from polyolefins, polyethylenes, polypropylenes, polyesters, polystyrenes, acetonitrile-butadiene-styrene resins, melamines, polycarbonates, phenolic resins, epoxies and polyurethanes, natural materials selected from rice hulls, corn cobs, and the like, nepheline syenite, or talc and mixtures thereof;
water; and
optionally, one or more materials selected from perfumes and perfume stabilizers, builders, rheology stabilizers; pH and buffering agents, electrolytes, pigments, colorants and the like.

Compositions according to the invention are alkaline in character, desirably having a pH of about 12 or more, exhibit very favorable viscosity characteristics, are good hard surface cleaners and feature good bleach stability over time. The compositions may also include minor amounts, generally not more than at total of 10% wt., desirably less than 5% wt. of one or more optional constituents including ones which may improve the aesthetic appeal of the compositions, viz., perfumes and colorants. Such optional constituents should not undesirably affect the shelf stability or rheology of the compositions.

The chlorine source can be either organic or inorganic including alkali metal and alkaline earth metal hypohalites, hypohalite addition products, haloamines, haloinines, haloimides, and haloamides. These also produce hypohalous bleaching species in situ. Preferred is hypochlorite and compounds producing hypochlorite in aqueous solution, although hypobromite is another potential halogen bleach. Those bleaching agents which yield a hypochlorite species in aqueous solution, include alkali metal and alkaline earth metal hypochlorites, hypochlorites addition products, chloramines, chlorimines, chloramides, and chlorimides. Examples of compounds of this type include sodium, potassium, lithium, and calcium hypochlorite, monobasic calcium hypochlorite, dibasic magnesium hypochlorite, chlorinated trisodium phosphate dodecahydrate, potassium dichloroisocyanurate, sodium dichloroisocyanurate, sodium dichloroisocyanurate dihydrate, trichlorocyanuric acid, 1,3-dichloro-5,5-dimethylhydantoin, N-chlorosulfamide, Chloramine T, Dichloramine T, Chloramine B and Dichloramine B.

At lower pH levels, aqueous solutions formed by dissolving hypochlorite-yielding compounds contains active chlorine, partially in the form of hypochlorous acid moieties and partially in the form of hypochlorite ions. At pH levels above about 10, which is preferred for compositions containing hypochlorite, essentially all (greater than 99%) of the active chlorine is reported to be in the form of hypochlorite ion.

Most of the above-described hypochlorite-yielding bleaching agents are available in solid or concentrated form and are dissolved in water during preparation of the compositions of the instant invention. Some of the above materials are available as aqueous solutions.

The above-described bleaching agents are dissolved in the aqueous liquid component of the present composition and are present in an active amount of from about 0.1% to 15% available chlorine.

Compositions of the present invention also include at least one surfactant selected from anionic surfactant, amine oxides, and mixtures thereof. By way of non-limiting example useful anionic surfactants include, for example, alkali metal salts, ammonium salts, amine salts, or aminoalcohol salts of one or more of the following compounds (linear and secondary): alcohol sulfates and sulfonates, alcohol phosphates and phosphonates, alkyl sulfates, alkyl ether sulfates, sulfate esters of an alkylphenoxy polyoxyethylene ethanol, alkyl monoglyceride sulfates, alkyl sulfonates, olefin sulfonates, paraffin sulfonates, beta-alkoxy alkane sulfonates, alkylamidoether sulfates, alkylaryl polyether sulfates, monoglyceride sulfates, alkyl ether sulfonates, ethoxylated alkyl sulfonates, alkylaryl sulfonates, alkyl benzene sulfonates, alkylamide sulfonates, alkyl monoglyceride sulfonates, alkyl carboxylates, alkyl sulfoacetates, alkyl ether carboxylates, alkyl alkoxy carboxylates having 1 to 5 moles of ethylene oxide, alkyl sulfosuccinates, alkyl ether sulfosuccinates, alkylamide sulfosuccinates, alkyl sulfosuccinamates, octoxynol or nonoxynol phosphates, alkyl phosphates, alkyl ether phosphates, taurates, N-acyl taurates, fatty taurides, fatty acid amide polyoxyethylene sulfates, isethionates, acyl isethionates, and sarcosinates, acyl sarcosinates, or mixtures thereof. Generally, the alkyl or acyl radical in these various compounds comprise a carbon chain containing 12 to 20 carbon atoms.

Examples of the foregoing anionic surfactants are available under the following tradenames: RHODAPON, STEPANOL, HOSTAPUR, SURFINE, SANDOPAN, NEODOX, BIOSOFT, and AVANEL.

Amine oxide compounds which can be used in the present invention may be defined as one or more of the following of the four general classes:
(1) Alkyl di (lower alkyl) amine oxides in which the alkyl group has about 6-24, and preferably 8-18 carbon atoms, and can be straight or branched chain, saturated or unsaturated. The lower alkyl groups include between 1 and 7 carbon atoms, but preferably each include 1-3 carbon atoms. Examples include octyl dimethyl amine oxide, lauryl dimethyl amine oxide, myristyl dimethyl amine oxide, and those in which the alkyl group is a mixture of different amine oxides, such as dimethyl cocoamine oxide, dimethyl (hydrogenated tallow) amine oxide, and myristyl/palmityl dimethyl amine oxide;
(2) Allyl di (hydroxy lower alkyl) amine oxides in which the alkyl group has about 6-22, and preferably 8-18 carbon atoms, and can be straight or branched chain, saturated or unsaturated. Examples include bis-2-hydroxyethyl) cocoamine oxide, bis-(2-hydroxyethyl) tallowamine oxide; and bis-(2-hydroxyethyl) stearylamine oxide;
(3) Alkylamidopropyl di(lower alkyl) amine oxides in which the alkyl group has about 10-20, and preferably 12-16 carbon atoms, and can be straight or branched chain, saturated or unsaturated. Examples are cocoamidopropyl dimethyl amine oxide and tallowamidopropyl dimethyl amine oxide; and
(4) Alkylmorpholine oxides in which the alkyl group has about 10-20, and preferably 12-16 carbon atoms, and can be straight or branched chain, saturated or unsaturated.

While these amine oxides recited above may be used, preferred are amine oxides which may be represented by the following structural representation: 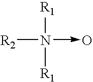
wherein
each R₁ independently is a straight chained C₁-C₄ alkyl group; and,
R₂ is a straight chained C₆-C₂₂ alkyl group or an alkylamidoalkylene having the formula 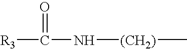
where R₃ is C₅-C₂₀ alkyl or
   —(CH₂)ₚ—OH
where n is 1 to 5 and p is 1 to 6; additionally, R₂ or R₃ could be ethoxylated (1 to 10 moles EO/mol) or propoxylated (1 to 10 moles of PO/mol).

Each of the alkyl groups may be linear or branched, but most preferably are linear. Examples include Ammonyx® LO which is described to be as a 30% wt. active solution of lauryl dimethyl amine oxide; Ammonyx® CDO Special, described to be a about 30% wt. active solution of cocoamidopropylamine oxide, as well as Ammonyx® MO, described to be a 30% wt. active solution of myristyldimethylamine oxide, all available from Stepan Company (Northfield, Ill.) with similar materials also available from Lonza under the Barlox trademark.

Some of the aforementioned surfactants are bleach-stable but some are not. When the composition contains a hypochlorite bleach, it is preferable that the detergent surfactant is bleach-stable. Such surfactants desirably do not contain functions such as unsaturation and some aromatic, amide, aldehydic, methyl keto or hydroxyl groups which are susceptible to oxidation by the hypochlorite.

The surfactant component, selected from anionic surfactants, amine oxides, and mixtures thereof, is present in the compositions of the present invention in an amount of from about 0.1 to about 10% by weight.

At least one thickener is used in the present compositions. One example of thickeners contemplated herein include organic polymeric thickeners include polycarboxylate polymers having a molecular weight from about 500,000 to about 4,000,000, preferably from about 1,000,000 to about 4,000,000, with, preferably, from about 0.5% to about 4% crosslinking. Preferred polycarboxylate polymers include polyacrylate polymers including those sold under trade names Carbopol®, Acrysol® ICS-1 and Sokalan®. The preferred polymers are polyacrylates. Other monomers besides acrylic acid can be used to form these polymers including such monomers as ethylene and propylene which act as diluents, and maleic anhydride which acts as a source of additional carboxylic groups. Another example of polymeric based thickeners are those based on polyacrylamides. One example is Solagum from Seppic.

Another class of thickeners include colloid-forming clays, for example, such as smectite and/or attapulgite types. Inorganic colloid forming clays tend to provide higher stability in the presence of chlorine and do not thin when subjected to shear.

The clay materials can be described as expandable layered clays, i.e., aluminosilicates and magnesium silicates. The term “expandable” as used to describe the instant clays relates to the ability of the layered clay structure to be swollen, or expanded, on contact with water. The expandable clays used herein are those materials classified geologically as smectites (or montmorillonite) and attapulgites (or polygorskites). Smectites are three-layered clays. There are two distinct classes of smectite-type clays. In the first, aluminum oxide is present in the silicate crystal lattice; in the second class of smectites, magnesium oxide is present in the silicate crystal lattice. The general formulas of these smectites are Al₂(Si₂O₅)₂(OH)₂ and Mg₃(Si₂O₅)(OH)₂, for the aluminum and magnesium oxide type clays, respectively. It is to be recognized that the range of the water of hydration in the above formulas may vary with the processing to which the clay has been subjected.

Commercially available clays include, for example, montmorillonite (bentonite), volchonskoite, nontronite, beidellite, hectorite, saponite, sauconite and vermiculite. The clays herein are available under various trade names such as Gelwhite H NF and Gelwhite GP from Southern Clay Products. (both montmorillonites); Van Gel O from R. T. Vanderbilt, smectites, laponites and layered silicates from Southern Clay Products. A second type of expandable clay material useful in the instant invention is classified geologically as attapulgite (polygorskite). Attapulgites are magnesium-rich clays having principles of superposition of tetrahedral and octahedral unit cell elements different from the smectites. Like the smectites, attapulgite clays are commercially available. For example, such clays are marketed under the tradename Attagel, i.e. Attagel 40, Attagel 50 and Attagel 150 from Engelhard Minerals & Chemicals Corporation.

The thickener component may be used in amounts of about 0.1 to 10 wt -%.

Another component of the present invention is at least one abrasive. Examples of abrasive materials include oxides, carbonates, quartzes, siliceous chalk, diatomaceous earth, colloidal silicon dioxide, alkali metasilicates, organic abrasive materials selected from polyolefins, polyethylenes, polypropylenes, polyesters, polystyrenes, acetonitrile-butadiene-styrene resins, melamines, polycarbonates, phenolic resins, epoxies and polyurethanes, natural materials selected from rice hulls, corn cobs, and the like, nepheline syenite, or tale and mixtures thereof. The particle size of the abrasive agent can range from about 1 μm to about 1000 μm, preferably between about 10 μn to about 200 μm, and more preferably between about 10 μm and about 100 μm. It is preferred to us those abrasive agents that will not scratch glass or ceramic surfaces. Such abrasive agents include calcium carbonate, siliceous chalk diatomaceous earth, colloidal silicon dioxide, sodium metasilicate, talc, and organic abrasive materials. Calcium carbonate is preferred. The amount of abrasive material can range from about 5 to about 30 wt %.

As noted the compositions may also include minor amounts, generally not more than at total of 10% wt., desirably less than 5% wt. of one or more optional constituents including ones which may improve the aesthetic appeal of the compositions, viz., perfumes and colorants. Such optional constituents should not undesirably affect the shelf stability or rheology of the compositions. By way of non-limiting example such further constituents include one or more coloring agents, fragrances and fragrance solubilizers, viscosity modifying agents, other surfactants, pH adjusting agents and pH buffers including organic and inorganic salts, optical brighteners, opacifying agents, hydrotropes, antifoaming agents, enzymes, anti-spotting agents, anti-oxidants, preservatives, and anti-corrosion agents. When one or more of the optional constituents is added, i.e., fragrance and/or coloring agents, the esthetic and consumer appeal of the product is often favorably improved. The use and selection of these optional constituents is well known to those of ordinary skill in the art.

### EXAMPLES

For purposes of illustration of the present inventive compositions, various formulations were produced and are reported below.

Into a suitably sized vessel, a measured amount of room temperature water (˜20° C.) was provided after which measured amounts of remaining constituents were added. All of the remaining constituents were similarly supplied at room temperature; mixing of the constituents was achieved by the use of a magnetic stirrer apparatus. Mixing, which generally lasted several minutes, and maintained until the particular exemplary formulation appeared to be homogeneous.

It is to be noted that the constituents may be added in any order. In some instances, the thickener is added first and then followed by water to form a thickened system to which the other components are added and in other instances, a premix of water and thickener is made which is then added to another mixture which contains the remaining components.

Exemplary inventive formulations according to the present invention including certain specifically preferred embodiments are shown in Table 1. The quantities of composition components are given as percentages by weight (wt %). Unless otherwise noted, the components in Table 1 are at 100% active.

TABLE 1

| | Ex. 1 | Ex. 2 | Ex. 3 | Ex. 4 | Ex. 5 | Ex. 6 |
|---|---|---|---|---|---|---|
| Components | Wt % | Wt % | Wt % | Wt % | Wt % | Wt % |
| DI Water | 41.28 | 39.33 | 36.33 | 39.28 | 30.00 | 33.00 |
| Carbopol 676 (1.5%) | 26.67 | 26.67 | 26.67 | 26.67 | 30.00 | 30.00 |
| Oxy-Rite 100 | 0.05 | | | 0.05 | 13.00 | |
| Gelwhite H NF (5%) | 10.00 | 10.00 | 10.00 | 10.00 | | 10.00 |
| Sodium Hydroxide (50%) | 1.50 | 1.50 | 1.50 | 1.50 | 1.50 | 1.50 |
| Sodium Hypochlorite (16%) | 7.00 | 7.00 | 7.00 | 7.00 | 7.00 | 7.00 |
| Calcium Carbonate | 10.00 | 12.00 | 15.00 | 12.00 | 15.00 | 15.00 |
| Ammonyx MO | 1.00 | 1.00 | 1.00 | 1.00 | 1.00 | 1.00 |
| Genopur BK | 2.50 | 2.50 | 2.50 | 2.50 | 2.50 | 2.50 |
| Total | 100.00 | 100.00 | 100.00 | 100.00 | 100.00 | 100.00 |

TABLE 1

| | Ex. 7 | Ex. 8 | Ex. 9 | Ex. 10 | Ex. 11 | Ex. 12 |
|---|---|---|---|---|---|---|
| Components | Wt % | Wt % | Wt % | Wt % | Wt % | Wt % |
| DI Water | 23.50 | 42.00 | 43.00 | 39.50 | 43.00 | 33.33 |
| Gelwhite GP (5%) | 10.00 | 5.00 | 5.00 | 3.00 | 5.00 | 15.00 |
| Carbopol 676 (1.5%) | 42.00 | 33.00 | 30.00 | 35.00 | 33.00 | 26.67 |
| Sodium Hydroxide (50%) | 1.50 | 1.50 | 1.50 | 1.50 | 1.50 | 1.50 |
| Sodium Hypochlorite | 7.00 | 7.00 | 7.00 | 7.00 | 7.00 | 7.00 |
| Calcium Carbonate | 12.50 | 9.00 | 10.00 | 10.00 | 7.00 | 12.00 |
| Titanium Dioxide | | | | 0.50 | 0.50 | |
| Ammonyx MO | 1.00 | 1.00 | 1.00 | 1.00 | 1.00 | 1.00 |
| Genopur BK | 2.50 | 1.50 | 2.50 | 2.50 | 2.00 | 3.50 |
| Total | 100.00 | 100.00 | 100.00 | 100.00 | 100.00 | 100.00 |

TABLE 1

| | Ex. 13 | Ex. 14 | Ex. 15 | Ex. 16 | Ex. 17 | Ex. 18 |
|---|---|---|---|---|---|---|
| Components | Wt % | Wt % | Wt % | Wt % | Wt % | Wt % |
| DI Water | 36.33 | 38.00 | 41.33 | 28.50 | 33.50 | 27.00 |
| Carbopol 676 (1.5%) | 26.67 | 30.00 | 26.67 | 45.00 | 40.00 | 30.00 |
| Gelwhite H NF (5%) | 15.00 | 10.00 | 10.00 | | | 16.00 |
| Sodium Hydroxide (50%) | 1.50 | 1.50 | 1.50 | 1.00 | 1.00 | 1.00 |
| Sodium Lauryl Ether Sulfate | | | | 1.50 | 1.50 | 1.50 |
| Sodium Carbonate | | | | | | 0.50 |
| Sodium Silicate | | | | 1.00 | 1.00 | |
| Sodium Hypochlorite (16%) | 7.00 | 7.00 | 7.00 | 7.00 | 7.00 | 7.00 |
| Calcium Carbonate | 10.00 | 10.00 | 10.00 | 15.00 | 15.00 | 16.00 |
| Ammonyx MO | 1.00 | 1.00 | 1.00 | 1.00 | 1.00 | 1.00 |
| Genopur BK | 2.50 | 2.50 | 2.50 | | | |
| Total | 100.00 | 100.00 | 100.00 | 100.00 | 100.00 | 100.00 |

TABLE 1

| | Ex. 19 | Ex. 20 | Ex. 21 | Ex. 22 | Ex. 23 | Ex. 24 |
|---|---|---|---|---|---|---|
| Components | Wt % | Wt % | Wt % | Wt % | Wt % | Wt % |
| DI Water | 41.33 | 10.00 | 19.00 | 36.00 | 10.00 | 20.03 |
| Carbopol 676 (1.5%) | 26.67 | 30.00 | 54.00 | 35.00 | 10.00 | 26.67 |
| Van Gel O | | | | | 50.00 | |
| Mineral Colloid BP | | | | | | 30.00 |
| Laponite (4%) | | 37.50 | | | | |
| Gelwhite H NF (5%) | 10.00 | | 1.00 | 5.00 | | |
| Sodium Hydroxide (50%) | 1.50 | 1.00 | 2.00 | 1.50 | 1.00 | 0.30 |
| Sodium Carbonate | | 1.00 | | | 1.00 | |
| Sodium Hypochlorite (16%) | 7.00 | 7.00 | 7.00 | 7.00 | 7.00 | 7.00 |
| Sodium Lauryl Ether Sulfate | | | | | 1.00 | 1.00 |
| Calcium Carbonate | 10.00 | 12.00 | 15.00 | 12.00 | 20.00 | 15.00 |
| Ammonyx MO | 1.00 | | | 1.00 | | |
| Biosoft D-40 | | 1.50 | 2.00 | | | |
| Genopur BK | 2.50 | | | 2.50 | | |
| Total | 100.00 | 100.00 | 100.00 | 100.00 | 100.00 | 100.00 |

TABLE 1

| | Ex. 25 | Ex. 26 | Ex. 27 | Ex. 28 | Ex. 29 | Ex. 30 |
|---|---|---|---|---|---|---|
| Components | Wt % | Wt % | Wt % | Wt % | Wt % | Wt % |
| DI Water | 36.33 | 33.00 | 33.00 | 50.33 | 20.00 | 17.50 |
| Gelwhite GP (5%) | 15.00 | 15.00 | 15.00 | | | |
| Solagum SF 306 | | | | 1.00 | | |
| Laponite (5%) | | | | | 28.00 | 30.00 |
| Carbopol 676 (1.5%) | 26.67 | 30.00 | 30.00 | 26.67 | 30.00 | 30.00 |
| Sodium Hydroxide (50%) | 1.50 | 1.50 | 1.50 | 1.50 | 1.50 | 1.50 |
| Sodium Hypochlorite (16%) | 7.00 | 7.00 | 7.00 | 7.00 | 7.00 | 7.00 |
| Calcium Carbonate | 10.00 | 10.00 | 10.00 | 10.00 | 10.00 | 10.00 |
| Ammonyx MO | 1.00 | 1.00 | 1.00 | 1.00 | | 3.50 |
| Genopur BK | | | 2.50 | | | 0.50 |
| Sodium Lauryl Ether Sulfate | 2.50 | 2.50 | | 2.50 | 3.50 | |
| Total | 100.00 | 100.00 | 100.00 | 100.00 | 100.00 | 100.00 |

TABLE 2

| | |
|---|---|
| DI Water | Deionized water |
| Carbopol 676 (1.5%) | Highly cross-linked polyacrylate polymer |
| | (Noveon; 100% active; added as 1.5% |
| | active solution in water |
| Oxy-Rite 100 | Aromatic based rheological stabilizer |
| | (Noveon; 100% active) |
| Gelwhite H NF (5%) | Montmorillonite (Southern Clay Products, |
| | Inc.; 100% active; added as 5% active |
| | solution in water) |
| Sodium Hydroxide (50%) | Sodium hydroxide (50% active solution |
| | in water) |
| Sodium Hypochlorite (16%) | Sodium hypochlorite (16% active solution |
| | in water) |
| Calcium Carbonate | Calcium carbonate |
| Ammonyx MO | Myristyldimethylamine oxide (Stepan; |
| | 30% active) |
| Genopur BK | Mixture of anionic surfactants |
| | (Clariant) |
| Gelwhite GP (5%) | Montmorillonite (Southern Clay Products, |
| | Inc.; 100% active; added as 5% active |
| | solution in water) |
| Titanium Dioxide | Titanium oxide |
| Sodium Lauryl Ether Sulfate | Sodium lauryl ether sulfate |
| Sodium Carbonate | Sodium carbonate |
| Sodium Silicate | Sodium silicate |
| Van Gel O | Hydrated magnesium aluminum silicate |
| | (smectite) clay (R T Vanderbilt) |
| Mineral Colloid BP | high purity montmorillonite (Southern |
| | Clay Products, Inc.; 100% active) |
| Laponite (4%); Laponite (5%) | Synthetic layered magnesium silicate |
| | (Southern Clay Products, Inc.; 100% |
| | active; added as a 4% (or 5%) active |
| | solution in water) |
| Biosoft D-40 | Sodium linear alkylbenzene sulfonate |
| | (Stepan; 38% active) |
| Solagum SF 306 | Polyacrylamide co-polymer (Seppic) |

The compositions of the present invention are expected to have good cleaning and/or disinfecting properties as described herein.

1. A liquid thickened chlorine bleach composition comprising:
an active chlorine source;
at least one surfactant selected from anionic surfactants, amine oxides, and mixtures thereof;
at least one thickener selected from polycarboxylates, polyacrylamides, clays, gums, cellulose derivatives, and mixtures thereof;
at least one abrasive material selected from oxides, carbonates, quartzes, siliceous chalk, diatomaceous earth, colloidal silicon dioxide, alkali metasilicates, organic abrasive materials selected from polyolefins, polyethylenes, polypropylenes, polyesters, polystyrenes, acetonitrile-butadiene-styrene resins, melamines, polycarbonates, phenolic resins, epoxies and polyurethanes, natural materials selected from rice hulls, corn cobs, and the like, nepheline syenite, or talc and mixtures thereof;
water; and
optionally, one or more materials selected from perfumes and perfume stabilizers, builders, rheology stabilizers; pH and buffering agents, electrolytes, pigments, colorants and the like.

2. The composition according to claim 1 wherein the surfactant is an amine oxide.

3. The composition according to claim 1 wherein the surfactant is a mixture of anionic surfactant and amine oxide.

4. The composition according to claim 1 wherein the anionic surfactant is selected from alkyl sulfates and alkyl ether sulfates.

5. The composition according to claim 1 wherein the anionic surfactant is selected from alkyl ether sulfates.

6. The composition according to claim 1 wherein the thickener is a mixture of polycarboxylates and clays.

7. The composition according to claim 1 wherein the thickener is a mixture of polycarboxylates and polyacrylamides.

8. The composition according to claim 1 wherein the thickener is a polycarboxylates.

9. The composition according to claim 1 which contains a rheology modifier.

10. The composition according to claim 1 wherein the pH of the composition is 12 or greater.

11. The composition according to claim 1 wherein the active chlorine source is a hypochlorite bleach, and the surfactant does not comprise unsaturations.

12. The composition according to claim 1 wherein the active chlorine source is a hypochlorite bleach, and the surfactant does not comprise aldehydic, methyl keto or hydroxyl groups susceptible to oxidation by the hypochlorite.

13. (canceled)
